(19) United States
(12) Patent Application Publication
(10) Pub. No.: US 2026/0009679 A1
(43) Pub. Date: Jan. 8, 2026

(54) System and Method for Automated Crowd Temperature Monitoring

(71) Applicant: Eaigle Inc., Markham (CA)

(72) Inventors: Mahdi MARSOUSI, Maple (CA); Akshaya MISHRA, Whitby (CA); Amir HOSSEIN, North York (CA)

(73) Assignee: Eaigle Inc., Markham (CA)

(21) Appl. No.: 18/763,674

(22) Filed: Jul. 3, 2024

(51) Int. Cl. G01J 5/00; G01J 5/08; G01J 5/80; G06T 7/11; G06T 7/246; G06T 7/60; G06T 7/73; G06V 10/25; G06V 10/77; G06V 10/82; G06V 20/52

(52) U.S. Cl. CPC G01J 5/0025; G01J 5/0859; G01J 5/80; G06T 7/11; G06T 7/248; G06T 7/60; G06T 7/74; G06V 10/25; G06V 10/7715; G06V 10/82; G06V 20/53; G01J 2005/0077; G06T 2207/10024; G06T 2207/30088; G06T 2207/30196

(57) ABSTRACT

There is provided a system and method for automated crowd temperature monitoring from input visual data and input thermal data. The method including: receiving the input visual data and the input thermal data; calibrating registration of the input visual data and the input thermal data; detecting persons in the defined area using a trained artificial neural network; estimating a distance between each detected person and a location of the one or more sensors using the trained artificial neural network; estimating a plurality of skin temperatures of each detected person using the thermal data registered on the respective detected person in the visual data, each temperature estimation is adjusted based on the estimated distance of the respective person to the one or more sensors; and outputting the temperature.

### TECHNICAL FIELD

The following relates generally to tracking by detection technology; and more particularly, to a system and a method for automated crowd temperature monitoring.

### BACKGROUND

Crowd temperature monitoring is an approach to estimate temperature of people in a crowd, such as their human skin temperature, within a defined area. Identifying such a defined area is challenging due to occlusions, distance from camera and presence of foreign objects. For example, when such persons enter, and/or while they are within, a defined coverage area. In some cases, such persons can move about freely while in the coverage area. Tracking people individually while they are in crowds or other large groups is a substantial challenge in the art.

### SUMMARY

In an aspect of the present invention, there is provided a computer-implemented method for automated crowd temperature monitoring from input visual data and input thermal data, the input visual data and the input thermal data capturing a defined area with one or more persons therein from one or more sensors, the method comprising: receiving the input visual data and the input thermal data; calibrating registration of the input visual data and the input thermal data; detecting persons in the defined area using a first trained artificial neural network having an object detector, the input visual data comprises input to the trained artificial neural network; estimating a distance between each detected person and a location of the one or more sensors; estimating a plurality of skin temperatures of each detected person using the thermal data registered on the respective detected person in the visual data, each temperature estimation is adjusted based on the estimated distance of the respective person to the one or more sensors; and outputting the estimated skin temperatures for each detected person.

In a particular case of the method, the method further comprising detecting one or more landmarks for each detected person using a second trained artificial neural network, and constructing a feature embedding for each detected person using local patch around each detected landmark and assigning this feature embedding as a unique identifier for each detected person.

In another case of the method, the one or more detected landmarks are within an extracted bounding box for the detected person. 2

In yet another case of the method, the second trained artificial neural network comprises a U-net to extract a number of landmarks on the body of the detected person. However, any other type of neural networks, such as EfficientNet, ResNet, SegNet and PanNet and Yolo-X can be used for landmark detections.

In yet another case of the method, the plurality of estimated skin temperatures are weighted based on the body part used for the temperature estimation. 8

In yet another case of the method, the forehead is given higher weighting than other body parts.

In yet another case of the method, the body part used for the temperature estimation is determined using bounding boxes constructed around each body part and masked with a segmentation mask.

In yet another case of the method, calibrating registration of the input visual data and the input thermal data comprises determining an affine transformation that projects the input thermal data from a thermal image coordinate system to an image domain of the input visual data.

In yet another case of the method, calibrating registration of the input visual data and the input thermal data comprises receiving red-green-blue and thermal images from a bi-spectral camera during which time a number of light-emitting-diodes are placed on a grid with temperature around 36 to 40 degrees and with a red color on a black background, and wherein the positions of the light-emitting-diodes are detected for both the visual data and the thermal data, the affine transformation is determined as a map of positions of the light-emitting-diodes from the thermal images on the visual images.

In yet another case of the method, the method further comprising smoothing the estimated skin temperatures for each detected person, and wherein outputting the estimated skin temperatures for each detected person comprises outputting the smoothed skin temperatures for each detected person.

In another aspect of the present invention, there is provided a system for automated crowd temperature monitoring from input visual data and input thermal data, the input visual data and the input thermal data capturing a defined area with one or more persons therein from one or more sensors, the system comprising a processing unit in communication with a data storage, the data storage comprising executable instructions for the processing unit to execute: an input module to receive the input visual data and the input thermal data; a registration module to calibrate registration of the input visual data and the input thermal data; a machine learning module to detect persons in the defined area using a first trained artificial neural network having 6 an object detector, the input visual data comprises input to the trained artificial neural network; a distance module to estimate a distance between each detected person and a location of the one or more sensors; a temperature module to estimate a plurality of skin temperatures of each detected person using the thermal data registered on the respective detected person in the visual data, each temperature estimation is adjusted based on the estimated distance of the respective person to the one or more sensors; and an output module to output the smoothed temperature for each detected person.

In a particular case of the system, the machine learning module further detects one or more landmarks for each detected person using a second trained artificial neural network, and constructs a feature embedding for each detected person using local patch around each detected landmark and assigning this feature embedding as a unique identifier for each detected person.

In another case of the system, the one or more detected landmarks are within an extracted bounding box for the detected person.

In yet another case of the system, the second trained artificial neural network comprises a U-net to extract a number of landmarks on the body of the detected person.

In yet another case of the system, the plurality of estimated skin temperatures are weighted based on the body part used for the temperature estimation.

In yet another case of the system, the forehead is given higher weighting than other body parts.

In yet another case of the system, the body part used for the temperature estimation is determined using bounding boxes constructed around each body part and masked with a segmentation mask.

In yet another case of the system, calibrating registration of the input visual data and the input thermal data comprises determining an affine transformation that projects the input thermal data from a thermal image coordinate system to an image domain of the input visual data.

In yet another case of the system, calibrating registration of the input visual data and the input thermal data comprises receiving red-green-blue and thermal images from a bi-spectral camera during which time a number of light-emitting-diodes are placed on a grid with temperature around 36 to 40 degrees and with a red color on a black background, and wherein the positions of the light-emitting-diodes are detected for both the visual data and the thermal data, the affine transformation is determined as a map of positions of the light-emitting-diodes from the thermal images on the visual images.

In yet another case of the system, the temperature module further smooths the estimated skin temperatures for each detected person, and wherein outputting the output module outputs the smoothed skin temperatures for each detected person.

These and other aspects are contemplated and described herein. It will be appreciated that the foregoing summary sets out representative aspects of the system and method to assist skilled readers in understanding the following detailed description.

### BRIEF DESCRIPTION OF THE DRAWINGS

A greater understanding of the embodiments will be had with reference to the figures, in which:

FIG. 1 illustrates a block diagram of a system for automated crowd temperature monitoring, according to an embodiment;

FIG. 2 illustrates a flowchart of a method for automated crowd temperature monitoring, according to an embodiment

FIG. 3 illustrates illustrates an example diagrammatic overview of distance estimation in accordance with the system of FIG. 1;

FIG. 4 illustrates an example of a bounding box defining a person's left arm, and associated landmarks, in accordance with the system of FIG. 1;

FIG. 5 illustrates a diagrammatic example of a general object detector including a feature extraction method, a feature pyramid network (FPN) and a multi-hypothesis head for multi-scale bounding box detection in accordance with the system of FIG. 1;

FIG. 6 illustrates a diagrammatic example of a landmark estimation network using a U-net style network in accordance with the system of FIG. 1;

FIG. 7 illustrates a diagrammatic example of a segmentation mask estimation network using a U-net style network in accordance with the system of FIGS. 1; and

FIG. 8 illustrates an example flowchart for a method of estimating weighted average skin temperature, in accordance with an embodiment.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine, or device exemplified herein that executes instructions may include or otherwise have access to computer-readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer-readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application, or module herein described may be implemented using computer readable/executable instructions that may be stored or otherwise held by such computer-readable media and executed by the one or more processors.

Accurate human temperature measurement using thermal camera requires precise human skin region identification over multiple frames. Performing object detection, key point estimation, segmentation and tracking is not feasible using thermal camera due to poor distinction between various key regions of human in thermal measurement space. Therefore, a RGB camera is used to collect more measurement in RGB space.

The thermal and RGB measurement are taken simultaneously but using two different cameras, therefore, these two measurements required to be registered against each other. The system uses an automatic registration algorithm and a calibration setting to align measurements of thermal cameras with the RGB ones.

Identifying human skin region in a crowded environment using RGB camera are also challenging due to self and external occlusions. To address these challenges, proposed system, detects people, identifies key points, segments human body and anonymously track them over multiple frames and finally records temperature when skin region is visible to camera

The method and system constitute a generic object detector to detect humans in a crowded environment, a key point estimation method to identify important regions of human body which are ideal for thermal temperature measurements, and a tracker and data association algorithm which establish an anonymous association between same people for temporal integration of temperature over multiple frames.

The general object detector can employ any existing object detectors, such as MaskRCNN or Yolo or any other publicly available object detector to predict bounding boxes enclosing each person. A general description of object detector is included in the description for the illustration purpose only, however any type of object detector can be employed to detect bounding boxes surrounding people.

The detected bounding boxes are passed to a key point estimation algorithm to estimate key regions of human. Around each key-points a 128-dimensional feature embedding is constructed to anonymously keep track of a person over multiple frames.

Further, each key points within a detected bounding box are joined with their neighbours to create a human skeleton, then a foreground mask corresponding to the skeleton is constructed. The constructed foreground mask along with the RGB images are passed to a trained U-net for human body segmentation.

The thermal readings within the segmented human body over multiple frames are integrated to obtain final temperature reading for the said detected and tracked person.

Embodiments of the present disclosure provide systems and methods to automatically measure temperature of people using data from sensors inputted into computer vision and machine learning techniques. Embodiments of the present disclosure advantageously facilitate temperature screening of people in large crowds without requiring slowing of flow of the crowd. Embodiments of the present disclosure track each person and their respective temperature as such person passes through a defined coverage area and while such person is within the defined coverage area. In this way, each person entering the defined coverage area is tracked until that person leaves the defined coverage area. In various embodiments, at least two types of imaging sensor sources can be used: visual (for example, red-green-blue (RGB)) and thermal (for example, infrared). The visual sensors can be used to detect and track people within the defined coverage area, and the thermal sensors can be used to estimate skin temperature. Skin temperature determinations can use the following criteria:
Temperature can be read from specific parts of each person's body; for example, their forehead, T-zone, eyes, and the like.
An estimation of a distance can be used between a point in space of the temperature reading and the location of the thermal sensor making such reading.

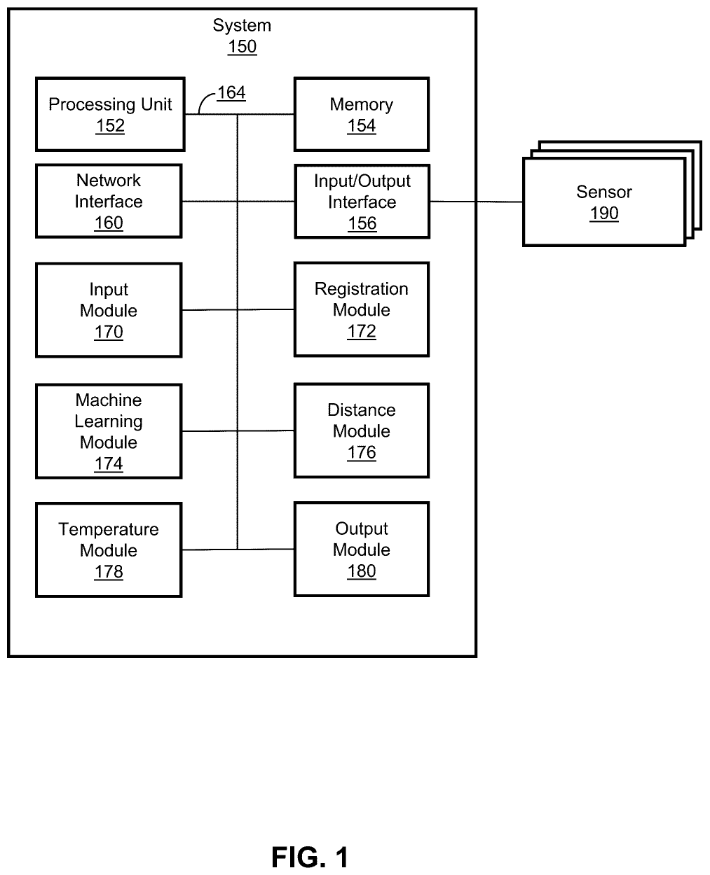

Addressing the above criteria allows the present embodiments to provide crowd temperature monitoring accurately and efficiently. Advantageously, the present embodiments address the above criteria, in some cases, by performing at least some of:
Detecting each single person in the defined coverage area using the visual sensors and the thermal sensors (for example, with a bi-spectral camera) and identifying at least some body parts of each person captured by the sensors.
Detecting 80 different class of objects, such as cup, mugs, computers in the defined coverage area using the visual sensors.
Tagging these 80 different class of objects as foreign object and excluding temperature measurements from foreign objects.
Estimating a distance between each person and the visual and/or thermal sensors at a specific timeframe (for example, at each frame).
Receiving skin temperatures estimations from one or more specific regions of interest on each person (for example, from the forehead, face, neck, and hands).
Adjusting temperature readings based on the distance between the person and the thermal sensors.
Excluding objects that are not part of a person's body from the temperature estimations that may have an elevated temperature (for example, mugs, cups, smartphones, and tablets).
Tracking persons, starting when such persons enter the defined coverage area until such person leaves the defined coverage area. While the persons are tracked, scoring the temperature estimations at each timeframe based on each person's pose and distance with respect to the thermal sensor.
Estimating a smoothed skin temperature for each person by combining the temperature estimations based on their respective scores. 2 Turning to FIG. 1, a system for automated crowd temperature monitoring 150 is

shown, according to an embodiment. In this embodiment, the system 150 is run on a local computing device (for example, a personal computer). In further embodiments, the system 150 can be run on any other computing device; for example, a server, a dedicated piece of hardware, a laptop computer, or the like. In some embodiments, the components of the system 150 are stored by and executed on a single computing device. In other embodiments, the components of the system 150 are distributed among two or more computer systems that may be locally or remotely distributed; for example, using cloud-computing resources.

FIG. 1 shows various physical and logical components of an embodiment of the system 150. As shown, the system 150 has a number of physical and logical components, including a processing unit 152 (comprising one or more processors), memory 154, an input/output interface 156, a network interface 160, and a local bus 164 enabling the processing unit 152 to communicate with the other components. The processing unit 154 can comprise microprocessors, microcontrollers, dedicated hardware circuits, or the like. The processing unit 152 executes instructions, such as in the context of an operating system, and executes various conceptual modules, as described below in greater detail. The memory 154 can provide both volatile and non-volatile data storage to the processing unit 152. The input/output interface 156 enables receiving of input via an input device, for example a mouse or a touchscreen. The input/output interface 156 can also output information to output devices, such as a display or speakers. The input/output interface 156 can also communicate with one or more sensors 190, for example visual sensors, such as video cameras and thermal cameras. In some cases, the thermal sensors and visual sensors can be collocated on a same device, such as with a bi-spectral camera. In further embodiments, the input/output interface 156 can retrieve already recorded sensor data from the memory 154 or a remote database via the network interface 160.

The network interface 160 permits communication with other systems, such as other computing devices and servers remotely located from the system 150, such as for a typical cloud-computing model. The memory 154 stores executable instructions for implementing the conceptual modules, as well as any data used by such modules. During operation of the system 150, various data may be retrieved from non-volatile storage and placed in volatile storage to facilitate execution. 2

In an embodiment, the system 150 further includes a number of conceptual modules to be executed on the one or more processors 152 by executing associated instructions in memory 154; including an input module 170, a registration module 172, a machine learning module 174, a distance module 176, a temperature module 178, and an output module 180. In further embodiments, the functions of the modules can be combined or run on other modules.

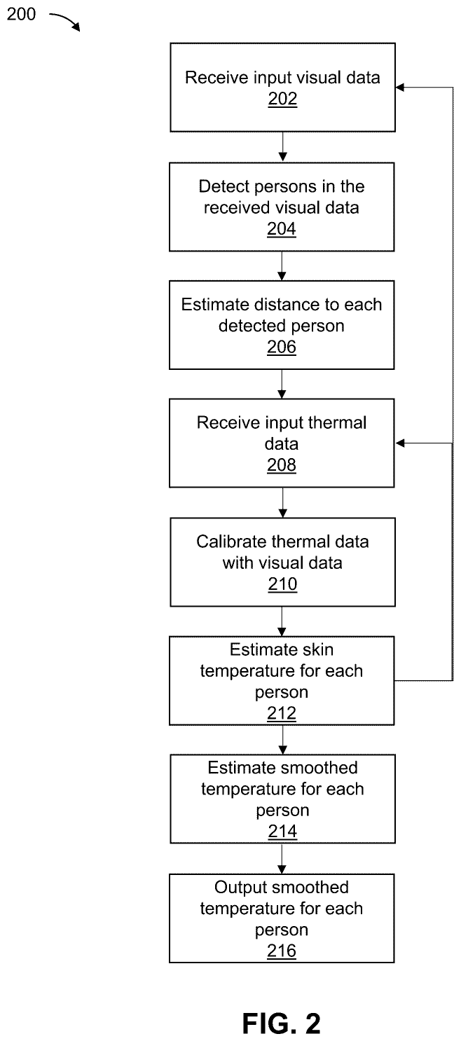

FIG. 2 illustrates a method 200 for automated crowd temperature monitoring, in accordance with an embodiment. At block 202, the input module 170 receives an input visual data from the one or more sensors 190 directed at a defined area. In some cases, the one or more sensors 190 can use bi-spectral imaging, which consists of thermal (e.g., infrared) data arranged into temporal frames of ‘thermal images’ and visual (e.g., RGB) data arranged into temporal frames of ‘visual images’. As described herein, the received RGB data is used to detect and track people, and the received infrared data is used to estimate the temperature of each respective tracked person. Generally, the two sensor channels (thermal and visual) have to be synchronized both spatially and temporally. For this purpose, each acquired thermal image from the thermal sensor is registered on a visual image. As described herein, this registration can be performed by determining and selecting the best matching visual image to the thermal image from a set of visual images taken at a higher framerate than the thermal image. In further cases, the one or more sensors 190 can comprise separate visual sensors and thermal sensors. The thermal and visual image are registered through a calibration process in which a limited number of LEDs are placed on a grid with temperature around 36 to 40 degrees and with red color on black background. A combination of RGB and thermal images are acquired from the bi-spectral camera and the LEDs' positions are detected on both RGB and thermal images. Then, an affine transformation is calculated to map the positions of LEDs from thermal on the RGB image. The affine transformation is then being used to register the thermal images on RGB images during the runtime.

In a particular case, the visual data can comprise images received from a high-resolution camera with a high framerate (such as 30 frames-per-second (FPS)). Timestamps of when each frame of the visual image was acquired can be stored along with, or associated with, the respective visual image frame. The thermal images, as described herein, can be received at a lower data resolution compared to the visual images, for example 320×280 pixels, and at a lower framerate, for example 10 FPS.

At block 204, the machine learning module 174 detects and tracks each person in the defined area. Generally, the machine learning module 174 uses an artificial neural network to perform a number of tasks, including detecting each person in the defined area with a bounding box around that person and determine a segmentation mask that specifies pixels in the visual image belonging to the detected person. In a particular case, the neural network can use a residual neural network based encoder to extract a set of features from each visual image. The machine learning module 174 can train the neural network to detect bounding boxes around each person present in the visual image. In an example, the neural network can use extracted features from the common objects in context (COCO) datasets and machine learning techniques to learn person detection in the visual images.

A region pooling technique can be used to pool the extracted features corresponding to each detected person. These extracted features can be used to train the neural network for, in some cases, segmenting each person from the background, localizing landmarks on each person's body, and detect each person's face. Given the detected faces, the machine learning module 174 can use another region pooling technique to pool the encoded features corresponding to the detected faces. The encoded features corresponding to the detected faces can be used by the machine learning module 174 to train a further artificial neural network to classify whether a face contains a facial mask or not.

For crowd temperature monitoring, tracking of each person is particular advantageous because it can avoid reporting multiple detections of the same person entering the coverage area, it can enable higher accuracy of temperature readings by combining multiple readings, and it can enable tracking cases with elevated skin temperature estimations for further investigation to avoid false alarm reporting.

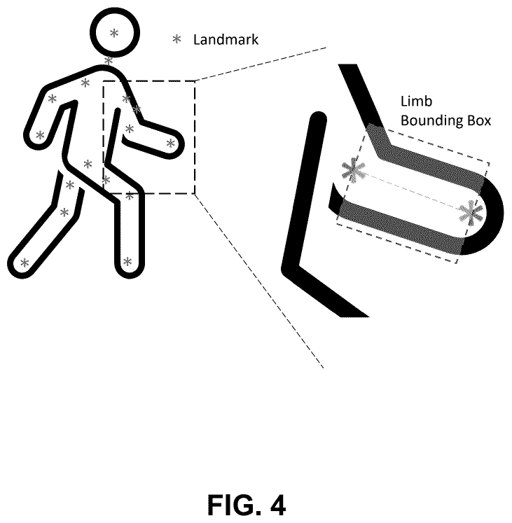

People tracking in crowd can be a challenging task, especially when different people occlude each other from a camera. To provide robust tracking, the machine learning module 174 can perform tracking based on features extracted from body parts of the tracked persons; such as using landmarks on the limbs of each person. For each detected person for a particular frame, limbs can be identified using associated landmarks. Landmarks can be various joints of the body (for example, elbows, knees, shoulders, hips, ankles, wrists, etc.), where each limb can be identified as a region encapsulated by two neighbor landmarks, or by a bounding box centered at a landmark (for example, the neck). Pixels associated with a limb can be considered pixels located inside the bounding box and with an active value in a corresponding segmentation mask to ensure pixels correspond to the detected person's body, and not anything else. FIG. 4 illustrates an example of a bounding box defining a person's left arm, and the associated landmarks.

In some cases, pixels corresponding to each limb can be converted from RGB to quantized HSV (Hue-Saturation-Value) color space. The Hue and Saturation values can be quantized from 255 values into N_{H} and N_{S} values for Hue and Saturation, respectively. By collecting pixels of a limb, a two-dimensional (2D) histogram matrix of the size of N_{H}×N_{S} can be generated and stored along with other information of the detected person for a given frame. The limbs matrices can be referred to as color features of the detected person.

Assume at each time frame, K active tracking cases are registered from previous tracking frames, and M new cases are detected in the new image frame. For each active tracking cases, the last N_{T} cases are stored. Each of the M new detections are compared with the K active tracking cases to determine whether each new detection corresponds to an active tracking case, or a new active tracking case should be added. This determination can be derived based on a global searching of M×K possible combinations. For each new detection and active tracking case, the color features of the new detection are compared with the N_{T} color features of the active tracking case based on a similarity metric. For computing similarity metric, a 128-dimensional feature vector is constructed for each detection by using color histogram. These feature vectors are updated for each active tracks. The similarity metric is computed by measuring the Euclidian distance between a new detection and all active tacks. The maximum similarity is picked for the combination of the new detection and the active tracking case. Once the similarity scores are determined, a global search is performed to associate new detections to active tracking cases. To make an association, the highest similarity score must be greater than a threshold value (τ=0.5), otherwise the new detection is not assigned to any active tracking case, and a new active tracking case is added for the new detection. As an example, given K active tracking cases, and M new detections:
Extract color features for new detections;
For each detection (D) from M new detections:
   Determine a similarity metric with active tracking cases; and
   Generate a matrix to store similarity metrics; and
Perform global searching to associate new detections to active tracking cases:
   Select highest value in the similarity matrix, sₘₐₓ;
   If sₘₐₓ(m,k)>τ, then associate new m^{th} detection to the k^{th} active tracking case; and
   Otherwise, create a new active tracking case.

FIG. 12 illustrates an example diagram of multi-component person detection, in accordance with the present embodiments.

At block 206, the distance module 176 estimates a distance to each detected person. The distance module 176 can use the determined bounding box and landmark(s) to estimate the distance of each person with respect to the one or more sensors 190.

Generally, it is preferable to finding not only the bounding box for each person in the visual image, but also find the segmentation mask of each detected person. The segmentation mask can be used to ensure thermal data of each person is only read from the body of the person and not anywhere else. For example, using a segmentation mask avoids reading high temperatures of objects in the background, such as due to the existence of a heater or any other source of heat. In this way, false elevated skin temperature alarms can be avoided.

The body landmarks can be used for both tracking of each person and detecting where to read thermal sensor data of such person. It can also be used to estimate the distance of the person to the thermal sensors.

In particular, face detection, along with landmarks associated with the face, can be advantageously used for temperature estimation. In a particular case, a box covering the whole human body is detected first, then from the detected neck landmark to the top of the body bounding box is classified as detected face. Corresponding the detected face to the detected person is particularly advantageous because otherwise a face of another person may be confused with the face of the detected person.

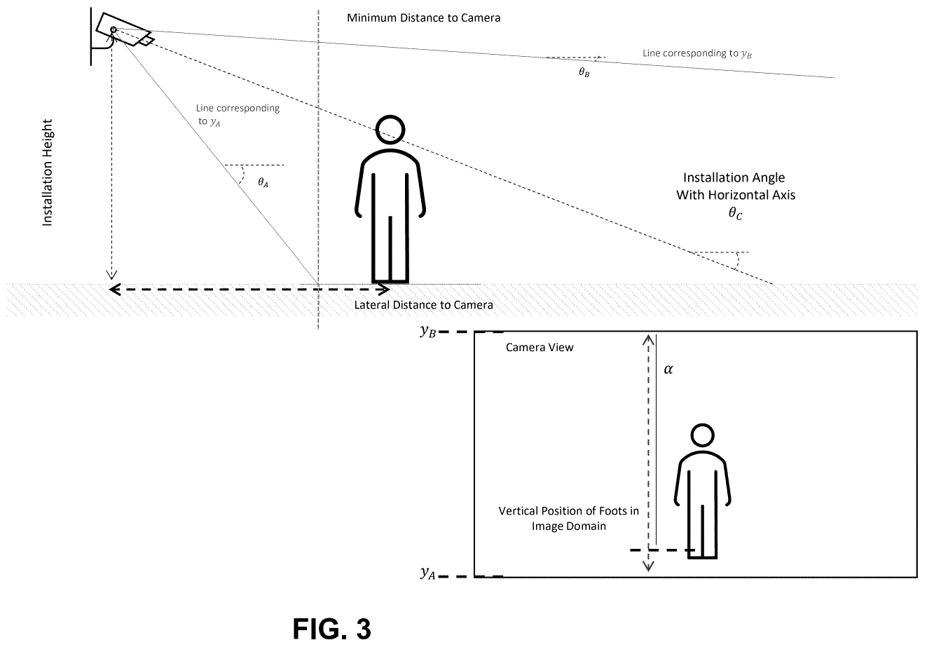

In some cases, the position of both feet landmarks, or the head landmark, in the visual image can be used by the distance module 176 to estimate the distance of a tracked person to the visual and/or thermal camera. This distance estimation can be determined by the distance module 176 using a trained regressor machine learning model. In other cases, the distance estimation can be determined by the distance module 176 using trigonometry. In these cases, installation height of the infrared camera can be assumed to be Y, the installation angle of the infrared camera with the horizontal axis is θ_{c}, the vertical field of view of the visual camera is VFOVRGB, and image height of the camera is H. The lateral distance of the detected person to the camera is determined using the following:

$$dist = - Y * C o t ( θ ) θ = ( 1 - α ) \times {θ}_{A} + α \times {θ}_{B} {θ}_{A} = ( {θ}_{C} - \frac{V F O V R G B}{2} ) , {θ}_{B} = ( {θ}_{C} + \frac{V F O V R G B}{2} ) α = \frac{{y}_{p} - {y}_{A}}{{y}_{B} - {y}_{A}} \qquad ( 1 )$$

where yₚ is the vertical coordinate of detected person's foot landmark, y_{A} is the maximum vertical coordinate of detected point (y_{A}=H), and y_{B} is the minimum vertical coordinate of detected point (y_{B}=0), θ_{A} and θ_{B} correspond to the angles of projected lines corresponding to y_{A} and y_{B} in the coordinate system. In some cases, if any of the feet are not visible, then the vertical coordinate of the head landmark can be used and Y can be substituted with Y−Y_{Avg}, where Y_{Avg} is the average height of the body. In further cases, any suitable body landmark of the person can be used. In most cases, distance determination requires persons to have a minimum distance from the infrared and visual cameras to ensure the person's feet are within the vertical field of view of the cameras; which can be referred to as a minimum distance to the cameras. FIG. 3 illustrates an example diagrammatic overview of the distance estimation approach.

At block 208, the input module 170 receives an input thermal data from the one or more sensors 190 directed at a defined area. As stated, the thermal data can be received at a lower data resolution and framerate compared to the visual data. The thermal sensor provides data for temperature estimation for certain defined body locations of the tracked persons. Thus, for accurate human body temperature predictions, the determined localization and distance of each person and their respective body parts can be used.

At block 210, in some cases, the registration module 172 performs calibration for registration of thermal data (images) on visual data (images). In most cases, the visual and thermal cameras as part of the one or more sensors 190 can be physically collocated, and in some cases, fixed to each other or part of the same assembly. The thermal sensors and visual sensors are not moved relative to each other after calibration is completed. Calibration determines an affine transformation that projects the thermal data from the thermal image coordinate system to the image domain of the visual images. Time difference between acquiring the thermal images and visual images can also be determined for temporal-domain synchronization. The temporal synchronization of thermal and visual images is advantageous for accurate determination of the estimated skin temperature while the persons are moving; otherwise, the thermal and visual images may not be synced and precisely overlayed for moving subjects.

The thermal and RGB images can be registered through a calibration in which a limited number of LEDs are placed on a grid with temperature around 36 to 40 degrees and with red color on black background. A combination of RGB and thermal images are acquired from the bi-spectral camera and the LEDs' positions are detected on both RGB and thermal images. Then, an affine transformation is calculated to map the positions of LEDs from thermal on the RGB image. The affine transformation is then being used to register the thermal images on RGB images during the runtime

At block 212, the temperature module 178 estimates skin temperature for each detected person. The temperature module 178 uses the registered (also referred to as overlayed) thermal data on the visual image, which enables reading of temperatures of desired spots on the body of detected persons.

In a particular case, the temperature module 178 can use forehead, face, neck, and hands for temperature estimation of each person; however, in further cases, any suitable body parts and/or landmarks can be used for temperature estimation. Each body part used for temperature estimation has an associated weight that defines its respective influence in a final temperature estimation. Generally, the forehead can be given the highest weight; however, detecting forehead temperature may not always be possible, depending on the body pose with respect to the infrared camera and the wearing of garments that cover the forehead. In such cases, other body parts can have greater influence in temperature estimation. In a particular case, the following can be used for temperature estimation:

$${T}_{e s t}^{i} = \frac{{\sum }_{j} {T}_{j} \times {v}_{j} \times {w}_{j}}{{v}_{j} \times {w}_{j}} \qquad ( 2 )$$

where Tⱼ is the temperature estimation of body part j∈{forehead, face, neck, hands, . . . }, vⱼ is a Boolean flag specifying whether body part j is visible or not, and wⱼ is the respective weight of the body part. Forehead is generally given a significantly higher value compared to other body parts (for example, 100 times more than any other body part). In such cases, only using the forehead temperature for overall skin temperature estimation, Tₑₛₜⁱ, can be used. i refers to the frame number of the detected person.

To read temperature of each body part, Tⱼ, a bounding box around the corresponding body part landmark is set and masked with the segmentation mask of the detected person to ensure readings are only obtained from the person's body, not anything else. In some cases, for temperature readings on a person's face, neck, and forehead, pixels corresponding to other objects, such as eyeglass, hat, facemask, can be removed from the temperature reading. Pixels corresponding to these objects can be identified using semantic segmentation.

Once temperature of each body part is estimated, the temperature module 178 adjusts the estimated temperature value based on the estimated distance of the person to the camera at the corresponding image frame. The adjustment is performed using a polynomial (nonlinear) function obtained using any suitable approach, and provides adjusted temperature as follows:

$${T}_{j , a d j} = f ( {T}_{j} , dist ) = {b}_{0} + {b}_{1} d i s t + {b}_{2} d i s {t}^{2} + {b}_{3} {dist}^{3} + … \qquad ( 3 )$$

where {bₙ} are parameters of polynomial (nonlinear) function. In most cases, the other parameters of radiometry like humidity and emissivity can be assumed to be fixed to humidity=50% and Emissivity=0.99.

An advantage of the system 150 is the ability to track persons in the defined coverage area in order to provide more accurate temperature estimation from multiple temperature readings compared to just a single temperature reading. In some cases, temperature estimation can be affected by a head pose of detected persons with respect to the thermal camera. Generally, the most accurate readings correspond to an image frame with the detected person looking directly towards the camera. Each frame reading is being scored based on a number of factors, for example:
Head pose with respect to the camera;
Distance to the camera with respect to a reference distance (for example, a 3-meters reference distance); and
Forehead exposure.

The one or more sensors 190 continue to receive visual data and thermal data as more data periodically comes in. In this way, blocks 202 to 212 for new visual data, or blocks 208 to 212 for new thermal data, can be repeated.

At block 214, for each detected person, the temperature module 178 determines scores for temperature readings, and determines a smoothed temperature by determining a weighted average of the temperature readings.

At block 216, the output module 180 outputs the smoothed temperature estimation for each detected person to the input/output interface 156, the network interface 160, or to memory 154. In further embodiments, the estimated temperature can be outputted by the output module 180 without smoothing.

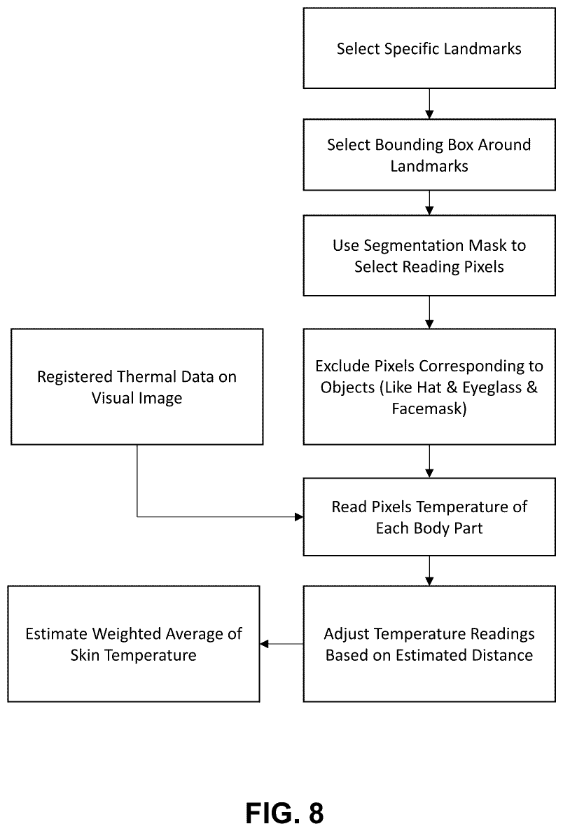

FIG. 8 illustrates an example flowchart for a method of estimating weighted average skin temperature in accordance with the present embodiments.

In an example embodiment, object detector used by the machine learning module 174 for detecting human body is a modified Yolov5.

The object detector based on modified Yolov5 accepts a batch of multi-channel image I_{bchw} of dimensions (b, c, h, w) and converts it to

$$( b , 4 c , \frac{h}{2} , \frac{w}{2} , c )$$

for efficient processing. The batch of images is organized as:

$${I}_{b 4 * c \frac{hw}{22}} = {I}_{bchw} ( : , : , 0 : 2 : h , : 0 : 2 : w ) + {I}_{bchw} ( : , : , 1 : 2 : h - 1 , 0 : 2 : c ) + {I}_{bchw} ( : , : , 0 : 2 : h , 1 : 2 : c - 1 ) + {I}_{bchw} ( : , : , 1 : 2 : h - 1 , 1 : 2 : c - 1 )$$

The height and widths are reduced by half and number of channels are increased by factor of four without any loss in image contents. The converted image is processed more efficiently using modern GPU architecture which support long vector multiplications

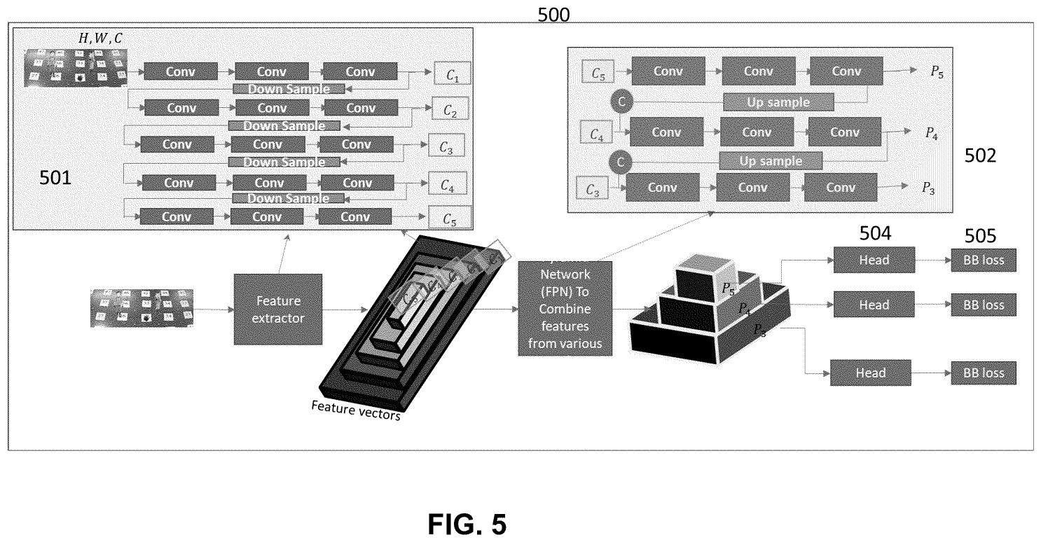

As shown in FIG. 5, the converted halt sized, and quadruple channel batch is passed to set of convolutions, batch normalization, activation, and pooling operators to generate features al five different scales: C₁, C₂, C₃, C₄ and C₅ and calculated as follows

$${C}_{1} = max - poll ( batch - norm ( relu ( conv ( conv ( conv ( {I}_{b 4 * c \frac{hw}{22}} ) ) ) ) ) ) ,$$

$${C}_{2} = max - poll ( batch - norm ( relu ( conv ( conv ( conv ( {C}_{1} ) ) ) ) ) )$$

$$C 2 - ( {C}_{2} + down - sample ( {C}_{1} )$$

$${C}_{3} = max - poll ( batch - norm ( relu ( conv ( conv ( conv ( {C}_{2} ) ) ) ) ) )$$

$$C 3 - ( {C}_{3} + down - sample ( {C}_{2} ) )$$

$${C}_{4} = max - poll ( batch - norm ( relu ( conv ( conv ( conv ( {C}_{3} ) ) ) ) ) )$$

$$C 4 = ( {C}_{4} + down - sample ( {C}_{3} ) + down - sample ( down - sample ( {C}_{2} ) ) )$$

$${C}_{5} = max - poll ( batch - norm ( relu ( conv ( conv ( conv ( {C}_{5} ) ) ) ) ) )$$

$$C 5 = ( {C}_{5} + down - sample ( {C}_{4} ) + down - sample ( down - sample ( down - sample ( {C}_{2} ) ) ) )$$

As shown in FIG. 5, these features are then combined using feature pyramid network to form multi-scale and multi-resolution feature pyramid: P₃, P₄, and P₅ and computed as:

$${P}_{5} = ( batch - norm ( relu ( conv ( conv ( conv ( C 5 ) ) ) ) ) ) ,$$

$${P}_{4} = up - sample ( P 5 ) + ( batch - norm ( relu ( conv ( conv ( conv ( C 4 ) ) ) ) ) ) ,$$

$${P}_{3} = up - sample ( P 4 ) + ( batch - norm ( relu ( conv ( conv ( conv ( C 3 ) ) ) ) ) ) ,$$

The feature pyramid network and there features from the feature pyramid P₃, P₄ and P₅ and their computations is demonstrated in FIG. 5.

These three features P₃, P₄ and P₅ at three different scales are fed to three detection heads to generate object hypothesis at three different scales. For example, for an image of height=256 and width=256, the (height, width) of features from P₃, P₄ and P₅ are

$$( \frac{256}{16} = 16 , \frac{256}{16} = 16 ) , ( \frac{256}{32} = 8 , \frac{256}{32} = 8 ) and ( \frac{256}{64} = 4 , \frac{256}{64} = 4 )$$

respectively. The features from P₅, P₄ and P₃ are suitable for large size human, medium size human and small size human respectively.

The head layers are also alternatively termed as decision layers. The head layers turn the feature vectors into interpretable outputs, in our case the outputs are set bounding boxes covering the visible portions of a human bodies. We define a bounding box using five parameters: bounding box center

$$( c {}_{x}^{bb} , c {}_{y}^{bb} ) ,$$

bounding box height (h^{bb}) and width (w^{bb}) and bounding box confidence (conf^{bb}). We generate a bounding hypothesis for every feature location corresponding to P₃, P₄ and P₅. For example, for an image of size (256, 256), we generate number 256, 64 and 16 number of bounding boxes hypothesizes corresponding to P₃, P₄ and P₅ feature layers. We encode these predicted boxes into a multidimensional vector of size [n, 5], where n is number of bounding box hypothesis. Let's term the predicted bounding box as ŷ=P^{bb}.

During learning/training phase, the ground truth for humans is provided in the form of bounding box labels. Let's term the bounding box label for ground truth box y=gt^{bb}. The method computes the difference between predicted bounding box ŷ and ground truth box y using a loss function. The loss function has two components: first one related to the confidence of pixel belonging to the presence of a human also termed as objectness and the second one related to the bounding box dimension covering the human. The confidence measure is represented using cross entropy loss function represented as:

$${L}_{conf} = CE ( \hat{y} ( {conf}^{bb} ) , y ( {conf}^{bb} ) ) = - {\sum }_{i} y ( {conf}^{bb} ) log ( \hat{y} ( {conf}^{bb} ) + ( 1 - y ( {conf}^{bb} ) ) log ( 1 - \hat{y} ( {conf}^{bb} ) ) .$$

The bounding box loss represented using IOU loss represented as:

$${L}_{bb} = 1 - IOU ( A , B ) = 1 - \frac{A ⋂ B}{A ⋃ B} ,$$

Where A and B are areas enclosing the ground truth box A and predicted box B.

The method predicts a human hypothesis at each feature locations, however it is not guaranteed the presence of a true human at feature locations, therefore there is one-to-one mapping between predicted bounding box and ground truth bounding box. The method uses following approach to assign a predicted bounding box to a ground truth bounding box:
a. Given a predicted bounding box, compute its IOU with respect to all ground truth bounding box
b. Compute the maximum value of computed IOU from step (a) and assign this to L_{bb}
c. If max-IOU is greater than 0.7 or less than 0.3, then compute L_{conf} using ŷ as:

$$\hat{y} ( {conf}_{bb} ) = \{ \begin{matrix}1 , & max - IOU > 0.7 \\ 0 , & max - iou < 0.3\end{matrix}$$

otherwise, do not compute the L_{conf} for this predicted box
d. Repeat (a) to (c) for all predicted bounding boxes

The method combines L_{bb} and L_{conf} and optimizes them using ADAM optimizers for 100 numbers of epochs.

The initial model parameters are estimated by training the model using publicly available COCO and VOC datasets and the final parameters are estimated by fine tuning the model using in-house datasets.

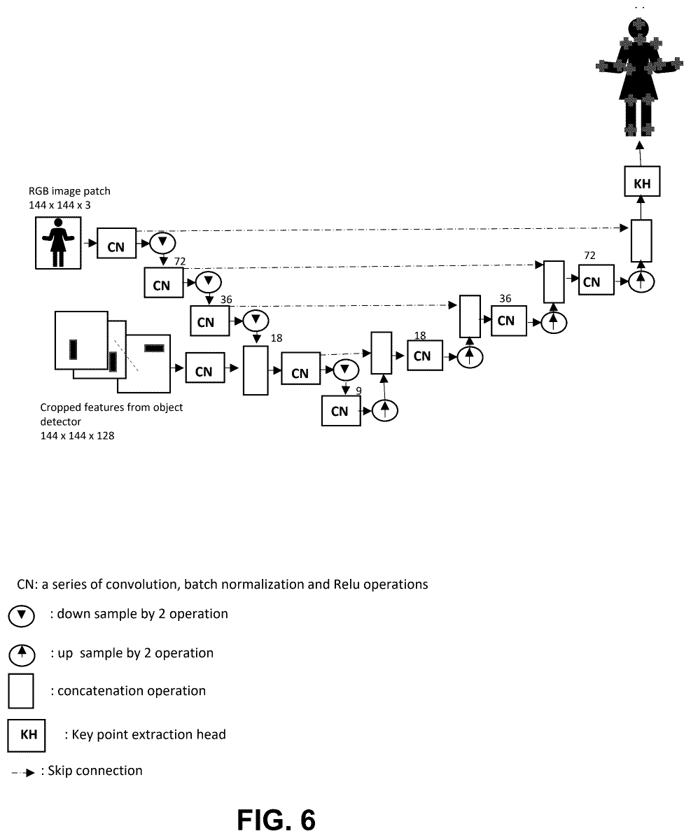

The process of landmark generation using the detected bounding box is demonstrated in FIG. 6, where, a modified U-net is used to extract a pre-defined number of landmark positions. The modified U-net accept two inputs: 1) a image patch cropped using the previously predicted bounding box of size 144×144×3 and 2) a multi-channel feature map of size 144×144×128 cropped using the previously predicted bounding box features. These two features are mixed at a compressed domain using a series of convolution, down-sampling, batch normalization, activations, and concatenation operations. The compressed images is project back to decompressed domain where the landmark positions are represented using heat maps (2D Gaussians)

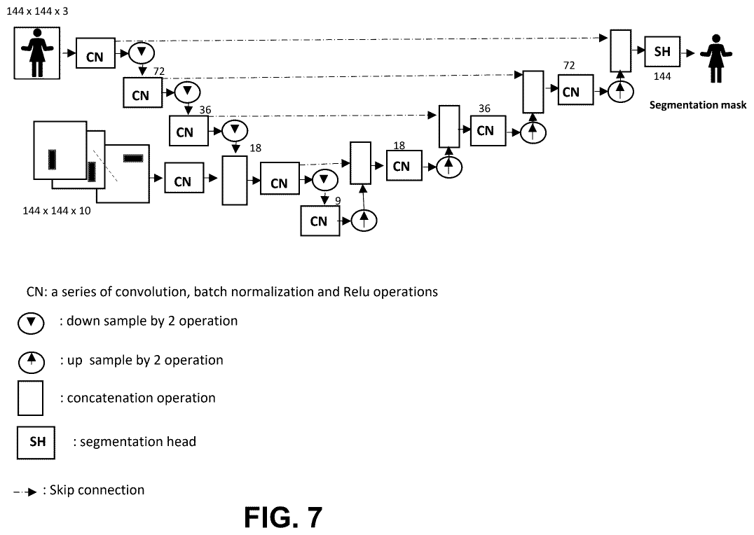

The process of segmentation mask generation using the detected bounding box is demonstrated in FIG. 7, where a modified U-net is used to extract a binary mask of human body enclosed inside a detected bounding box. The modified U-net accept two inputs: 1) an image patch cropped using the previously predicted bounding box of size 144×144×3 and 2) a multi-channel heat map of landmark positions of size 144×144×10. These two features are mixed at a compressed domain using a series of convolution, down-sampling, batch normalization, activations, and concatenation operations. The compressed features are projected back to a decompressed domain where pixels corresponding to human body are represented as 1 and rest of the pixels are represented as 0.

Although the foregoing has been described with reference to certain specific embodiments, various modifications thereto will be apparent to those skilled in the art without departing from the spirit and scope of the invention as outlined in the appended claims. The entire disclosures of all references recited above are incorporated herein by reference.

1. A computer-implemented method for automated crowd temperature monitoring from input visual data and input thermal data, the input visual data and the input thermal data capturing a defined area with one or more persons therein from one or more sensors, the method comprising:
receiving the input visual data and the input thermal data;
calibrating registration of the input visual data and the input thermal data;
detecting persons in the defined area using a first trained artificial neural network having an object detector, the input visual data comprises input to the trained artificial neural network;
estimating a distance between each detected person and a location of the one or more sensors;
estimating a plurality of skin temperatures of each detected person using the thermal data registered on the respective detected person in the visual data, each temperature estimation is adjusted based on the estimated distance of the respective person to the one or more sensors; and
outputting the estimated skin temperatures for each detected person.

2. The method of claim 1, further comprising detecting one or more landmarks for each detected person using a second trained artificial neural network, and constructing a feature embedding for each detected person using local patch around each detected landmark and assigning this feature embedding as a unique identifier for each detected person.

3. The method of claim 2, wherein the one or more detected landmarks are within an extracted bounding box for the detected person.

4. The method of claim 2, wherein the second trained artificial neural network comprises a U-net architecture or any other neural network architecture to extract a number of landmarks on the body of the detected person.

5. The method of claim 1, wherein the plurality of estimated skin temperatures are weighted based on the body part used for the temperature estimation.

6. The method of claim 4, wherein the forehead is given higher weighting than other body parts.

7. The method of claim 4, wherein the body part used for the temperature estimation is determined using bounding boxes constructed around each body part and masked with a segmentation mask.

8. The method of claim 1, wherein calibrating registration of the input visual data and the input thermal data comprises determining an affine transformation that projects the input thermal data from a thermal image coordinate system to an image domain of the input visual data.

9. The method of claim 7, wherein calibrating registration of the input visual data and the input thermal data comprises receiving red-green-blue and thermal images from a bi-spectral camera during which time a number of light-emitting-diodes are placed on a grid with temperature around 36 to 40 degrees and with a red color on a black background, and wherein the positions of the light-emitting-diodes are detected for both the visual data and the thermal data, the affine transformation is determined as a map of positions of the light-emitting-diodes from the thermal images on the visual images.

10. The method of claim 1, further comprising smoothing the estimated skin temperatures for each detected person, and wherein outputting the estimated skin temperatures for each detected person comprises outputting the smoothed skin temperatures for each detected person.

11. A system for automated crowd temperature monitoring from input visual data and input thermal data, the input visual data and the input thermal data capturing a defined area with one or more persons therein from one or more sensors, the system comprising a processing unit in communication with a data storage, the data storage comprising executable instructions for the processing unit to execute:
an input module to receive the input visual data and the input thermal data;
a registration module to calibrate registration of the input visual data and the input thermal data;
a machine learning module to detect persons in the defined area using a first trained artificial neural network having an object detector, the input visual data comprises input to the trained artificial neural network;
a distance module to estimate a distance between each detected person and a location of the one or more sensors;
a temperature module to estimate a plurality of skin temperatures of each detected person using the thermal data registered on the respective detected person in the visual data, each temperature estimation is adjusted based on the estimated distance of the respective person to the one or more sensors; and
an output module to output the smoothed temperature for each detected person.

12. The system of claim 11, wherein the machine learning module further detects one or more landmarks for each detected person using a second trained artificial neural network and constructs a feature embedding for each detected person using local patch around each detected landmark and assigning this feature embedding as a unique identifier for each detected person.

13. The system of claim 12, wherein the one or more detected landmarks are within an extracted bounding box for the detected person.

14. The system of claim 12, wherein the second trained artificial neural network comprises a U-net or any other neural network to extract a number of landmarks on the body of the detected person.

15. The system of claim 11, wherein the plurality of estimated skin temperatures are weighted based on the body part used for the temperature estimation.

16. The system of claim 14, wherein the forehead is given higher weighting than other body parts.

17. The system of claim 14, wherein the body part used for the temperature estimation is determined using bounding boxes constructed around each body part and masked with a segmentation mask.

18. The system of claim 11, wherein calibrating registration of the input visual data and the input thermal data comprises determining an affine transformation that projects the input thermal data from a thermal image coordinate system to an image domain of the input visual data.

19. The system of claim 17, wherein calibrating registration of the input visual data and the input thermal data comprises receiving red-green-blue and thermal images from a bi-spectral camera during which time a number of light-emitting-diodes are placed on a grid with temperature around 36 to 40 degrees and with a red color on a black background, and wherein the positions of the light-emitting-diodes are detected for both the visual data and the thermal data, the affine transformation is determined as a map of positions of the light-emitting-diodes from the thermal images on the visual images.

20. The system of claim 11, wherein the temperature module further smooths the estimated skin temperatures for each detected person, and wherein outputting the output module outputs the smoothed skin temperatures for each detected person.
